(19) United States
(12) Patent Application Publication
(10) Pub. No.: US 2019/0014644 A1
(43) Pub. Date: Jan. 10, 2019

(54) INTERMEDIARY DEVICE

(71) Applicant: Legrand Electric Limited, Birmingham (GB)

(72) Inventor: Merlin Milner, London (GB)

(73) Assignee: Legrand Electric Limited, Birmingham, OT (GB)

(21) Appl. No.: 15/748,724

(22) PCT Filed: Jul. 29, 2016
(86) PCT No.: PCT/GB2016/052348

§ 371 Date: Jan. 30, 2018

(30) Foreign Application Priority Data
Jul. 31, 2015 (GB) 1513600.5

(51) Int. Cl. H05B 37/02

(52) U.S. Cl. CPC H05B 37/0272; G08C 2201/93

(57) ABSTRACT

There is provided a lighting control system 1. The lighting control system comprises a portable device 10 comprising a communication unit configured for communication using a first communication protocol over a first communication channel 16. The portable device 10 is configured to send a lighting controller instruction via the communication unit. The lighting control system 1 also comprises a lighting controller 14 for controlling at least one light 20, 24, 28. The lighting controller 14 comprises a lighting controller communication unit configured for communication using a second communication protocol over a second communication channel 18 which is different to the first communication channel 16. The lighting controller is configured to receive a lighting controller command wirelessly via the lighting controller communication unit. The lighting control system 1 also comprises an intermediary device 12 comprising a first intermediary communication unit configured for communication using the first communication protocol over the first communication channel 16. The intermediary device 12 is configured to receive the lighting controller instruction from the portable device 10. The intermediary device also comprises a second intermediary communication unit in data communication with the first intermediary communication unit and configured to send the lighting controller command wirelessly to the lighting controller 14 using the second communication protocol over the second communication channel 18.

This invention relates to an intermediary device, in particular for use between a programming device and lighting control equipment.

### BACKGROUND

A lighting system is sometimes controlled by lighting control equipment (LCE). A set of control rules is typically transmitted wirelessly to the LCE for controlling the lighting system. Programming the LCE wirelessly is often done via the medium of infrared or radio (RF) using a proprietary programming device/handset specific to the lighting control equipment manufacturer. The present invention, at least in some embodiments, seeks to provide at least an alternative to the prior art.

### BRIEF SUMMARY OF THE DISCLOSURE

In accordance with the present inventions there is provided a lighting control system. The lighting control system comprises a portable device comprising a communication unit configured for communication using a first communication protocol over a first communication channel. The portable device is configured to send a lighting controller instruction via the communication unit. The lighting control system also comprises a lighting controller for controlling at least one light. The lighting controller comprises a lighting controller communication unit configured for communication using a second communication protocol over a second communication channel which is different to the first communication channel. The lighting controller is configured to receive a lighting controller command wirelessly via the lighting controller communication unit. The lighting control system also comprises an intermediary device comprising a first intermediary communication unit configured for communication using the first communication protocol over the first communication channel. The intermediary device is configured to receive the lighting controller instruction from the portable device. The intermediary device also comprises a second intermediary communication unit in data communication with the first intermediary communication unit and configured to send the lighting controller command wirelessly to the lighting controller using the second communication protocol over the second communication channel.

Thus, a user of a portable device can send instructions to a lighting controller using a first communication channel which is different from a second communication channel which is available for the lighting controller. This is beneficial where the portable device is easy to use, but does not have the capability to communicate using the second communication channel. Alternatively, even if the portable device has the capability to communicate using the second communication channel, it may be easier to use the portable device to communicate using the first communication channel.

The portable device may be a handheld electronic device. The portable device may be for example a wearable device, a tablet computer, a mobile phone, a laptop computer, or a desktop device.

The first communication channel may be a wireless connection, for example a WiFi connection or a Bluetooth® connection. Alternatively, the first communication channel may be a wired connection, for example a USB connection. The first communication protocol may be, for example TCP/IP.

The second communication channel may be a wireless connection, for example a WiFi connection, a Bluetooth® connection or a proprietary RF communication channel. Alternatively, the second communication channel may be a wired connection, for example a USB connection. The second communication protocol may be, for example TCP/IP. The second communication protocol may be TCP/IP or may be a proprietary or standard communication protocol for communication with the lighting controller, for example.

The second communication channel may be infrared. The second intermediary communication unit may comprise a plurality of infrared transmitters whereby to transmit the lighting control command to a plurality of lighting controllers. Thus, the intermediary device can be used to send lighting controller commands to several different lighting controllers simultaneously.

At least two of the plurality of infrared transmitters may be arranged to emit infrared radiation in at least partly different directions. Thus, when the intermediary device is positioned in the centre of an area having several lighting controllers, each infrared transmitter may be substantially pointed at an infrared receiver in each of the lighting controllers.

The first intermediary communication unit may be capable of two-way communication with the portable device. Thus, the portable device can receive feedback from the intermediary device regarding sensor readings for sensors on the intermediary device or confirmation that lighting controller commands have been sent from the intermediary device. The second intermediary communication unit may be capable of two-way communication with the lighting controller. Thus, the intermediary device can receive feedback from the lighting controller that the lighting controller commands have been successfully received. This also allows the lighting controller to send information back to the intermediary device which may include sensor readings for sensors connected to the lighting controller. In some embodiments, the portable device can receive data from the lighting controller via the intermediary device.

The intermediary device may be adapted to be attached to at least one of: personal safety equipment, clothing, an extremity of a user, or directly to the portable device. Thus, the intermediary device is easily transportable around a building.

The present invention extends to an intermediary device for use in the lighting control system described previously. The intermediary device comprises a first intermediary communication unit configured for communication using a first communication protocol over a first communication channel. The intermediary device is configured to receive a lighting controller instruction from a portable device. The intermediary device further comprises a second intermediary communication unit in data communication with the first intermediary communication unit and configured to send a lighting controller command wirelessly to a lighting controller using a second communication protocol over a second communication channel which is different to the first communication channel.

Thus, the intermediary device enables a user of a portable device to send instructions to a lighting controller using a first communication channel which is different from a second communication channel which is available for the lighting controller. This is beneficial where the portable device is easy to use, but does not have the capability to communicate using the second communication channel. Alternatively, even if the portable device has the capability to communicate using the second communication channel, it may be easier to use the portable device to communicate using the first communication channel.

The intermediary device may further comprise a sensor unit. Thus, the intermediary device can comprise sensors which are not provided on a portable device, or can provide the ability to position the sensors desirably, whilst not constraining the movement of the portable device. The lighting controller command may be based on the lighting controller instruction and an output from the sensor unit. The sensor unit may be a lux sensor. Thus, the portable device can provide a lighting controller instruction to set the lights to a level corresponding to a preset lux level, and the intermediary device can use the lux sensor to provide adaptive feedback to enable the lighting controller command(s) to be modified as necessary to provide the required level of lighting.

Alternatively, the lighting controller instruction may be based at least in part on the output from the sensor unit. The intermediary device may provide the output from the sensor unit to the portable device. The sensor unit may be a lux sensor. Thus, the portable device can receive a lux level from the lux sensor and provide a lighting controller instruction to dim up or down the lights based on a preset lux level and the received lux level. Thus, the lighting controller command is based on the lighting controller instruction, and therefore also implicitly based on the output from the sensor unit.

The invention extends to a computer readable non-transitory storage medium comprising instructions which, when executed in an electronic device, configure the electronic device as the portable device in the lighting control system as described previously.

### BRIEF DESCRIPTION OF THE DRAWINGS

Embodiments of the invention are further described hereinafter with reference to the accompanying drawings, in which:

FIG. 1 is an illustration of a schematic representation of a lighting control system according to an embodiment of the present invention;

FIG. 2 is an illustration of a schematic representation of an intermediary device for use in the lighting control system of FIG. 1;

FIG. 3 is an illustration of a schematic representation of an alternative intermediary device to that shown in FIG. 2;

FIG. 4 is an illustration of a schematic representation of a second communication unit for use in either of the intermediary devices as shown in FIG. 2 or FIG. 3.

### DETAILED DESCRIPTION

The present invention allows a portable device, such as a handheld electronic device, such as a smart phone, a tablet, or a computer to be used as a programming device (PD) for uploading commands to lighting control equipment (LCE) via an intermediary device (ID). An application from the lighting control manufacturer is typically installed on the PD to facilitate use of the PD in this way.

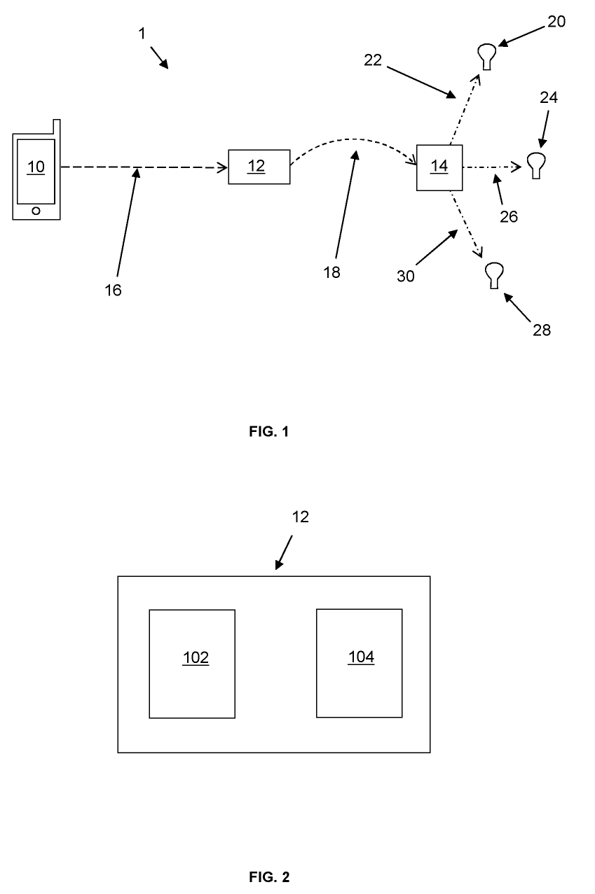

The ID is in effect an adaptor between the PD and the LCE. FIG. 1 is an illustration of a schematic representation of a lighting control system according to one embodiment of the present invention. A lighting control system 1 comprises a lighting controller 14, connected to three lighting devices 20, 24, 28 using three lighting communication channels 22, 26, 30. The lighting devices 20, 24, 28 are used to provide lighting in a region of a building. The connection from the lighting controller 14 to the first lighting device 20 uses a first lighting communication channel 22. The connection from the lighting controller 14 to the second lighting device 24 is uses a second lighting communication channel 26. The first lighting communication channel 22 and the second lighting communication channel 26 are wired. The connection from the lighting controller 14 to the third lighting device 28 is uses a third lighting communication channel 30. The third lighting communication channel 30 is a proprietary wireless communication channel.

The lighting controller 14 receives a lighting controller command based on a lighting controller instruction sent from a portable device 10. In this case, the portable device 10 is a mobile phone. The portable device 10 is connected to an intermediary device 12 using a first communication channel 16. The first communication channel 16 is Bluetooth®. The intermediary device 12 is connected to the lighting controller 14 using a second communication channel 18. The second communication channel 18 is infrared.

The lighting controller instructions are communicated from the portable device 10 to the intermediary device 12 using an encoding protocol. For example, the lighting controller instruction is to set the illumination level in the region of the building to be 400 lux between 9 AM and 6 PM. The lighting controller instruction is subsequently encoded using the encoding protocol into an encoded bit stream. The encoded bit stream is then sent from the portable device 10 to the intermediary device 12 over the first communication channel 16, which is Bluetooth®.

FIG. 2 is an illustration of a schematic representation of an intermediary device for use in the lighting control system of FIG. 1. The encoded bit stream is received at a first intermediary communication unit 102 of the intermediary device 12. After being received, the encoded bit stream is routed to a second intermediary communication unit 104 without decoding. The encoded bit stream already contains lighting controller commands and is sent from the second intermediary communication unit 104 of the intermediary device 12 to the lighting controller 14 using the second communication channel 18, which is infrared. The lighting controller 14 is configured to decode the lighting controller commands based on the knowledge of the encoding protocol used to encode the lighting controller commands.

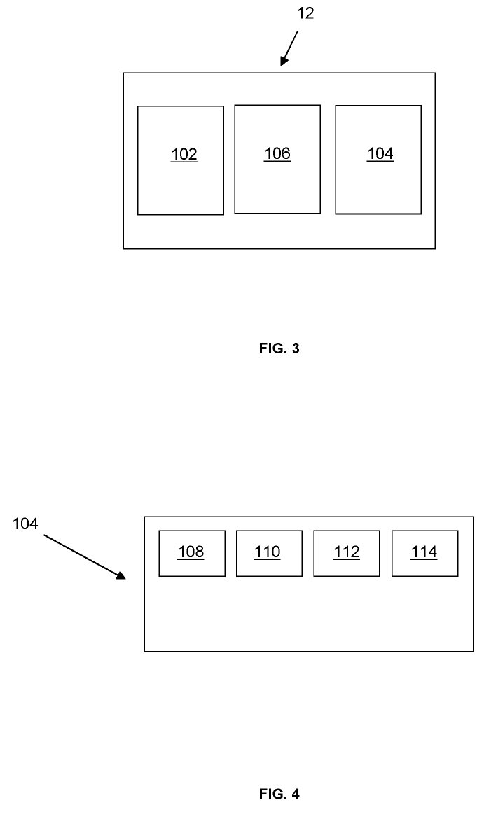

FIG. 3 is an illustration of a schematic representation of an alternative intermediary device to that shown in FIG. 2. In addition to the first communication unit 102 and the second communication unit 104, the intermediary device 12 comprises a sensor unit 106, such as a lux meter. The lighting controller instruction sent from the portable device 10 to the intermediary device 12 does not contain sufficient information to form a complete lighting controller command as required by the lighting controller 14. In this embodiment, the lighting controller instruction is decoded in the intermediary device 12. Additional information based on an output from the sensor unit 106 is added to the lighting controller instruction to form a complete lighting control command. The lighting control command is then encoded using the same, or a different, encoding protocol, and sent from the intermediary device 12 to the lighting controller 14, via the second intermediary communication unit 104 using the second communication channel 18, which is infrared. If a different encoding protocol is used, then the different encoding protocol is also used to decode the lighting control command at the lighting controller 14.

In some embodiments, the connection between the portable device 10 and the intermediary device 12 is bi-directional. When the intermediary device 12 comprises the sensor unit 106, the intermediary device 12 may send information from the sensor unit 106 to the portable device 10 using the first communication channel 16. This enables the portable device 10 to form and send a complete lighting controller command, such that the intermediary device 12 need not add information to the lighting controller instruction sent from the portable device 10 to the intermediary device 12, because the lighting controller instruction is already a lighting controller command that can be sent to the lighting controller 14.

For example, where the sensor unit 106 is a lux sensor, the user places the intermediary device 12 on a surface within the region covered by at least one of the lighting devices 20, 24, 28. The intermediary device 12 transmits the Lux light level output by the lux sensor to an application running on the portable device 10 to enable the user to read the Lux level. The user may want to set a particular light level that is maintained by dimming up or down the artificial lighting to compensate for the natural light entering via windows. If, for example, the user wants a maintained light level of 600 Lux and the lux sensor reads 400 Lux, the user enters 600 Lux on the application running on the portable device 10. The portable device 10 will send to the intermediary device 12 a lighting controller command to send to the lighting controller 14 to dim up the artificial lighting a preset amount. The intermediary device 12 transmits the new Lux light level output by the lux sensor to the application running on the portable device 10. If necessary, the portable device 10 will send to the intermediary device 12 a further lighting controller command to send to the lighting controller 14 to dim up or down the artificial lighting a second preset amount to compensate for any enduring change between the new Lux light level output by the lux sensor and the desired light level of 600 Lux. In an alternative embodiment, the portable device 10 will send to the intermediary device 12 the required Lux level. The intermediary device 12 and the lighting controller 14 will work together to dim the artificial lighting dimming up or down until 600 Lux is read by the lux meter. The maintained Lux level has now been set.

Although the first communication channel is previously described as being Bluetooth®, it will be appreciated that other wireless communication channels can be used, such as, for example, infrared, radio (RF) such as WiFi, or similar. In some embodiments, the first communication channel may be wired, for example using a serial link, TCP/IP, USB, or similar.

Similarly, although the second communication channel is previously described as being infrared, it will be appreciated that other wireless communication channels can be used such as, for example, a proprietary RF system, WiFi, Bluetooth® or similar.

Either or both of the first communication channel and the second communication channel can be a two-way communication channel to allow feedback of information to the portable device or the intermediary device.

The first communication unit 102 comprises at least a receiver and other electronics necessary to receive a lighting controller instruction from the portable device using the first communication channel. The second communication unit 104 comprises at least a transmitter and other electronics necessary to send a lighting controller command to the lighting controller 14.

The intermediary device 12 is configured to be mounted in a case of the portable device 10 and therefore attached to the portable device 10. However, it will be appreciated that in alternative embodiments, the intermediary device 12 may be worn on the head by, for example, being attached to a hat such as a hard hat, or mounted on a head band. Alternatively, the intermediary device 12 may be configured to be: placed freestanding on a surface such as a table or floor; mounted on a tripod; or worn on the wrist.

FIG. 4 is an illustration of a schematic representation of a second communication unit 104 for use in either of the intermediary devices 12 as shown in FIG. 2 or FIG. 3. In this particular embodiment, the second communication unit 104 comprises a plurality of Infrared transmitters 108, 110, 112, 114. Each of the infrared transmitters 108, 110, 112, 114 is arranged to direct infrared radiation in a different direction. A first infrared transmitter 108 is configured to be used specifically for targeted transmission towards a single lighting controller. By transmitting a lighting controller command using several or all of the infrared transmitters 108, 110, 112, 114, it is possible to send the lighting controller command to several lighting controllers at the same time using a single intermediary device. In order to increase the range or reliability of the second communication unit 104, each infrared transmitter 108, 110, 112, 114 may comprise a plurality of infrared light emitting diodes. Similarly, in some embodiments the number of infrared transmitters 108, 110, 112, 114 may be greater than or fewer than four.

In some embodiments, the intermediary device could be used as a security device or pairing aid as described in our co-pending application attached as an annex hereto.

The intermediary device could be used as the security device or pairing aid in conjunction with the App running on a Bluetooth® enabled mobile device. An intermediary device incorporating a Bluetooth® receiver and a wireless transceiver would translate wireless Bluetooth® signals into signals that can be understood by the lighting control system devices. An app on the Bluetooth® mobile device would then perform the same functions as the security device or pairing aid to allow secure pairing of devices. Only when the mobile device is in Bluetooth® range of the system device will pairing occur.

In summary, there is provided a lighting control system 1. The lighting control system comprises a portable device 10 comprising a communication unit configured for communication using a first communication protocol over a first communication channel 16. The portable device 10 is configured to send a lighting controller instruction via the communication unit. The lighting control system 1 also comprises a lighting controller 14 for controlling at least one light 20, 24, 28. The lighting controller 14 comprises a lighting controller communication unit configured for communication using a second communication protocol over a second communication channel 18 which is different to the first communication channel 16. The lighting controller is configured to receive a lighting controller command wirelessly via the lighting controller communication unit. The lighting control system 1 also comprises an intermediary device 12 comprising a first intermediary communication unit configured for communication using the first communication protocol over the first communication channel 16. The intermediary device 12 is configured to receive the lighting controller instruction from the portable device 10. The intermediary device also comprises a second intermediary communication unit in data communication with the first intermediary communication unit and configured to send the lighting controller command wirelessly to the lighting controller 14 using the second communication protocol over the second communication channel 18.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A lighting control system comprising:
a portable device comprising a communication unit configured for communication using a first communication protocol over a first communication channel, the portable device being configured to send a lighting controller instruction via the communication unit;
a lighting controller for controlling at least one light and comprising a lighting controller communication unit configured for communication using a second communication protocol over a second communication channel which is different to the first communication channel, the lighting controller being configured to receive a lighting controller command wirelessly via the lighting controller communication unit; and
an intermediary device comprising: a first intermediary communication unit configured for communication using the first communication protocol over the first communication channel, the intermediary device being configured to receive the lighting controller instruction from the portable device; a second intermediary communication unit in data communication with the first intermediary communication unit and configured to send the lighting controller command wirelessly to the lighting controller using the second communication protocol over the second communication channel; and a sensor unit, wherein the lighting controller command is based on the lighting controller instruction and an output from the sensor unit.

2. The lighting control system as claimed in claim 1, wherein the portable device is a handheld electronic device.

3. The lighting control system as claimed in claim 1, wherein the second communication channel is infrared.

4. The lighting control system as claimed in claim 3, wherein the second intermediary communication unit comprises a plurality of infrared transmitters whereby to transmit the lighting control command to a plurality of lighting controllers.

5. The lighting control system as claimed in claim 4, wherein at least two of the plurality of infrared transmitters are arranged to emit infrared radiation in at least partly different directions.

6. The lighting control system as claimed in claim 1, wherein the first intermediary communication unit is capable of two-way communication with the portable device.

7. The lighting control system as claimed in claim 1, wherein the second intermediary communication unit is capable of two-way communication with the lighting controller.

8. The lighting control system as claimed in claim 1, wherein the intermediary device is adapted to be attached to at least one of: personal safety equipment, clothing, or an extremity of a user.

9. An intermediary device for use in the lighting control system of claim 1, the intermediary device comprising:
a first intermediary communication unit configured for communication using a first communication protocol over a first communication channel, the intermediary device being configured to receive a lighting controller instruction from a portable device;
a second intermediary communication unit in data communication with the first intermediary communication unit and configured to send a lighting controller command wirelessly to a lighting controller using a second communication protocol over a second communication channel which is different to the first communication channel; and
a sensor unit,
wherein the lighting controller command is based on the lighting controller instruction and an output from the sensor unit.

10. The intermediary device as claimed in claim 9, wherein the sensor unit is a lux sensor.

11. A computer readable non-transitory storage medium comprising instructions which, when executed in an electronic device, configure the electronic device as the portable device in the lighting control system as claimed in claim 1.
